(19) United States
(12) Patent Application Publication
(10) Pub. No.: US 2015/0090619 A1
(43) Pub. Date: Apr. 2, 2015

(54) Saxophone Stand Buddy

(71) Applicant: Jerald L. BOYKIN, Baton Rouge, LA (US)

(72) Inventor: Jerald L. BOYKIN, Baton Rouge, LA (US)

(21) Appl. No.: 14/043,400

(22) Filed: Oct. 1, 2013

(51) Int. Cl. G10G 5/00

(52) U.S. Cl. CPC G10G 5/00
USPC 206/314

(57) ABSTRACT

A protective saxophone stand cover that protects a saxophone, when a saxophone is resting on a saxophone stand, being placed on a saxophone stand, and being removed from a saxophone stand. The protective saxophone stand cover may be constructed of a soft, non-abrasive material to protect against the saxophone from being scratched, dented, or otherwise damaged. The protective saxophone stand cover may include a securing strap to protect against a saxophone, while on a saxophone stand, from falling off of the stand or being knocked off of the saxophone stand.

This invention pertains to a new and distinct device for protecting saxophones from damage while saxophones are on, being placed on, or removed from saxophone stands.

### BACKGROUND OF THE INVENTION

Metallic musical instruments, such as alto saxophones, tenor saxophones, baritone saxophones, and bass saxophones, are typically constructed of soft-metal alloys, comprising brass (copper and zinc), bronze (copper and tin), and nickel-silver (copper, zinc, and nickel).

A person who plays a saxophone, when performing or when practicing, may encounter times during which said saxophone is placed on a saxophone stand, wherein said saxophone stand may be constructed of a metal that is harder than the soft metal alloy used for saxophones.

When saxophones are placed on or removed from saxophone stands, exterior parts of saxophones may be scratched or otherwise damaged by saxophone stands.

Saxophones also may be scratched, dented, or otherwise damaged if a saxophone, while in a saxophone stand, is bumped, shaken or otherwise caused to fall out of said saxophone stand.

Musical instruments that are scratched, dented, or otherwise damaged, may lose significant economic value.

The invention claimed herein is designed to prevent or diminish damage to saxophones, comprising scratching and/or denting, when a saxophone is being placed on, being removed from, or resting on a saxophone stand.

There are devices for protecting saxophones while said saxophone is being transported, stored, or played, but there do not appear to be any devices for protecting saxophones when said saxophones are placed on, removed from, or resting on saxophone stands.

We have found no patent, patent application, nor other literature describing a device for protecting saxophones when said saxophones are placed on, removed from, or resting on saxophone stands.

### BRIEF SUMMARY OF INVENTION

We disclose a new device for protecting valuable saxophones. This novel device comprises a protective covering that may be placed over a saxophone stand that prevents the saxophone stand from scratching or otherwise damaging a saxophone when the saxophone is placed on, removed from, or resting on a saxophone stand.

This novel device also attaches a saxophone to a saxophone stand in an easily reversible manner.

Protective saxophone stand coverings may be constructed of smooth material comprising silk, linen, Velvet®, foam, polyester, polyamide, velour, microfiber, suede, felt, leather, and cotton flannel that provides a barrier sufficient for preventing damage from the saxophone stand to a saxophone while in said saxophone stand.

The protective saxophone stand covering is designed to fit on typical saxophone stands. The protective saxophone stand covering is held in place on said saxophone stand by fitting the top part of the covering over the vertical extension on the top of said saxophone stands and fitting elastic bands on the protective saxophone covering over lower protrusion on said saxophone stand. Once placed on a saxophone stand, a saxophone is secured to the saxophone stand with a strap that detachably wraps around the saxophone. When one wants to remove the saxophone from the saxophone stand, the strap easily releases.

### BRIEF DESCRIPTION OF DRAWINGS

FIG. 1 depicts a front view of a protective saxophone stand cover.

FIG. 2 depicts a back view of a protective saxophone stand cover.

FIG. 3 depicts an exploded view of the back side of a protective saxophone stand cover.

FIG. 4 depicts a view of prior art, a typical saxophone stand.

FIG. 5 depicts a view of the protective saxophone stand cover in place on a typical saxophone stand.

FIG. 6 depicts a view of elastic bands on the back of the protective saxophone stand cover placed over lower horizontal extrusions on the saxophone stand.

### DETAILED DESCRIPTION OF THE INVENTION

Saxophones, comprising alto, tenor, baritone, and bass saxophones, are primarily constructed of soft metal, for example, brass, and exteriors of saxophones are subject to damage when saxophones come in contact with harder metals, for example saxophone stands.

Saxophones, comprising alto, tenor, baritone, and bass saxophones, may be damaged if bumped or knocked off a saxophone stand.

Saxophones may be protected from damage caused by saxophone stands or from knocking a saxophone off of a saxophone stand by placing a protective covering, with a securing strap, over the saxophone stand.

Protective saxophone stand coverings may be constructed of material that is smooth and scratch resistant and that provides a sufficient barrier between a saxophone and a saxophone stand. Material used for protective saxophone stand coverings comprise silk, linen, Velvet®, foam, polyester, polyamide, velour, microfiber, suede, felt, leather, and cotton flannel.

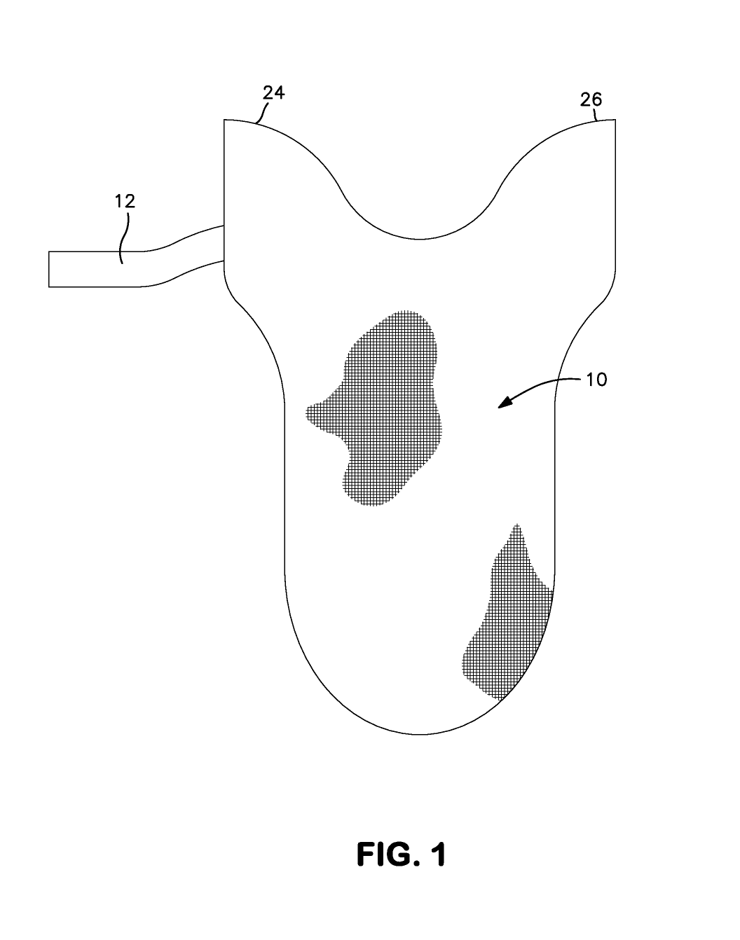

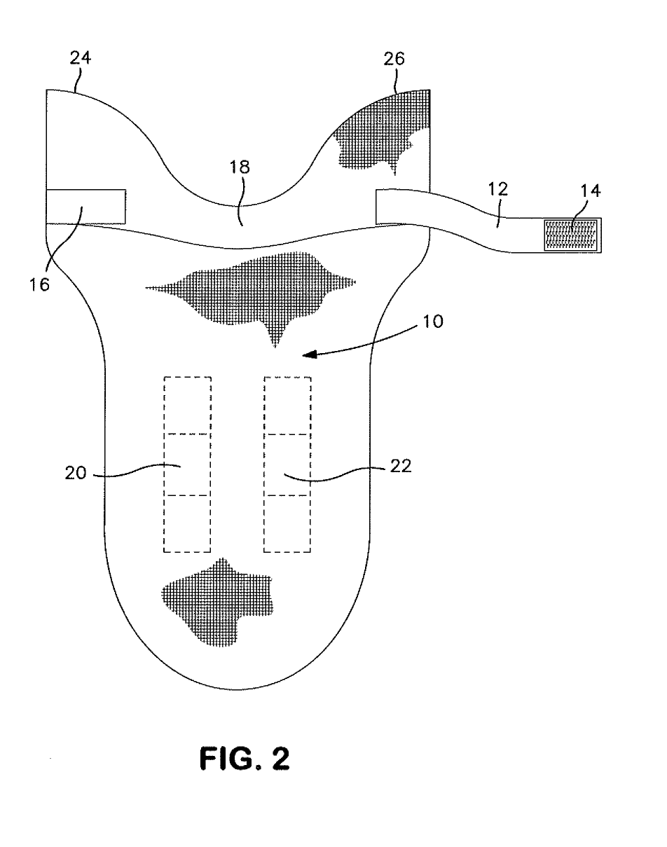

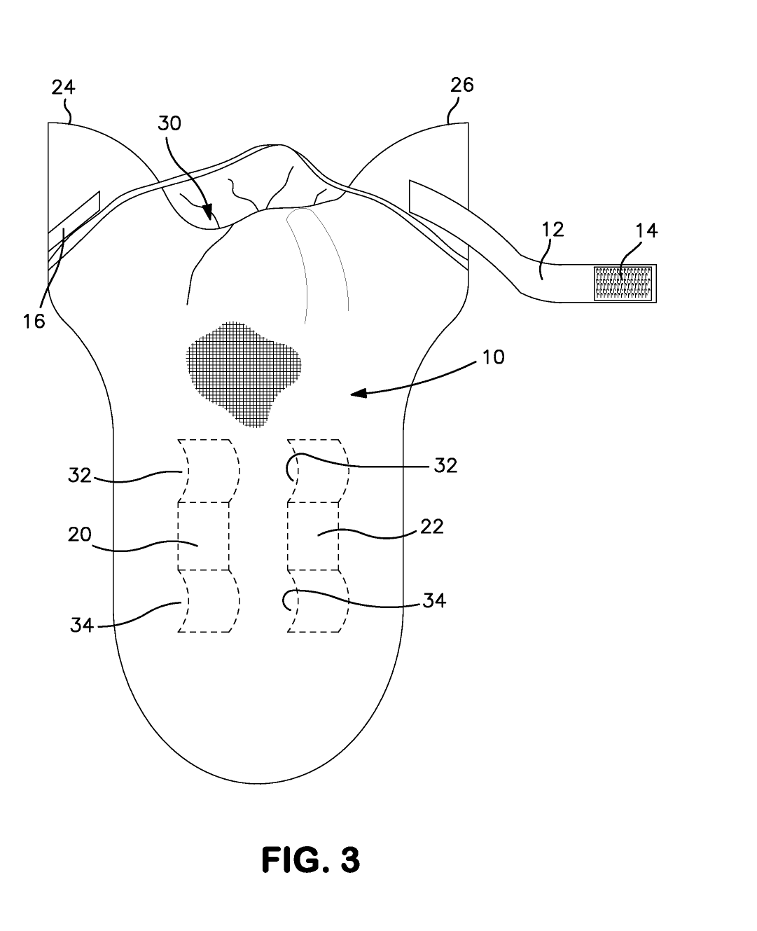

The protective saxophone stand cover 10 has a front side, as shown in FIG. 1, and a back side, as shown in FIGS. 2 and 3.

A securing strap 12 is depicted in FIGS. 1, 2, and 3. The securing strap, when wrapped around a saxophone resting in the saxophone stand, prevents the saxophone from falling off the stand.

The back side of the protective saxophone stand cover 10, is depicted in FIG. 2 and FIG. 3. A securing strap 12 is fixedly attached to a flap 18 on the back side of the protective covering 10 with a connecting device 14 at the distal end of the securing strap. On the opposite side to where the securing strap is fixedly attached is a mating device 16 that may mate with the connecting device 14. The connecting device comprises Velcro®, buckles, snaps, and hooks.

Two elastic loops 20 and 22 are fixedly attached near the bottom of the backside of the protective cover 10. The elastic loops may include two or more openings positioned to accommodate different sized saxophones.

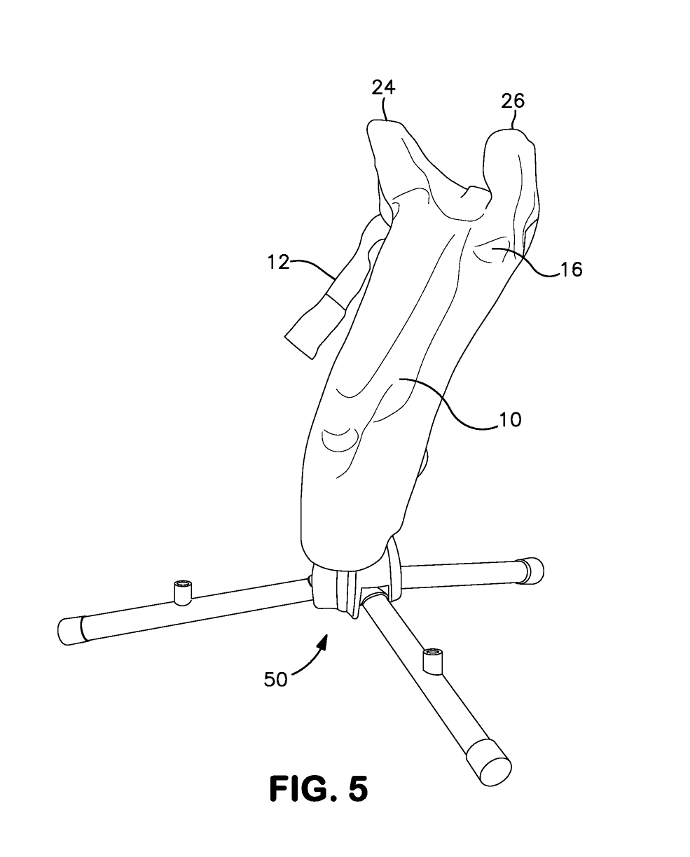

The top of the protective cover 10 comprises a curved outline with “ears” 24 and 26, a flap 18 that has an opening 30 (see FIG. 3) that fits over the top of a saxophone stand (see FIG. 5), a securing strap 12 attached at one end to the flap 18 with a mating device on its distal end 14, a receiving mechanism 16 that links with the mating device 14, and two elastic loops 20 and 22.

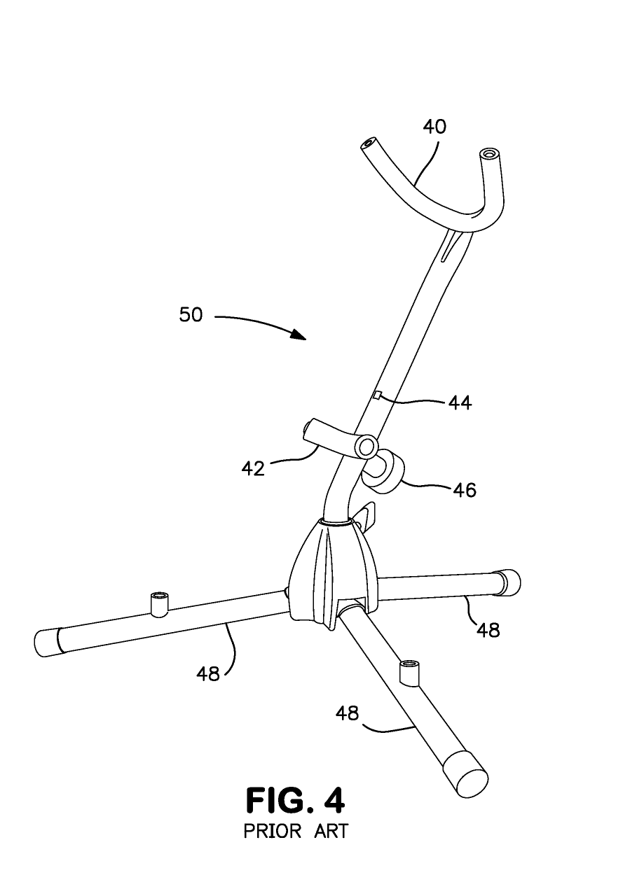

The protective saxophone stand cover 10 is placed over a prior art saxophone stand 50, as shown in FIG. 4. The saxophone stand 50 comprises a U-shaped top protrusion 40, an adjustable U-shaped bottom protrusion 42, a tighten device 46, a set of three legs 48, and a backbone 44. The backbone 44 may have two or more holes available to move the adjustable U-shaped lower protrusion 42 to different positions to accommodate different sized saxophones. The adjustable U-shaped lower protrusion 42 may be placed at approximately seven (7) inches below the U-shaped top protrusions 40 for alto saxophones and at approximately nine (9) inches below the U-shaped top protrusion 40 for tenor saxophones.

FIG. 5 illustrates the placement of the protective saxophone stand cover 10 on a saxophone stand 50.

The protective saxophone cover “ears” 24 and 26 fit over the U-shaped top protrusion 40 on a saxophone stand 50.

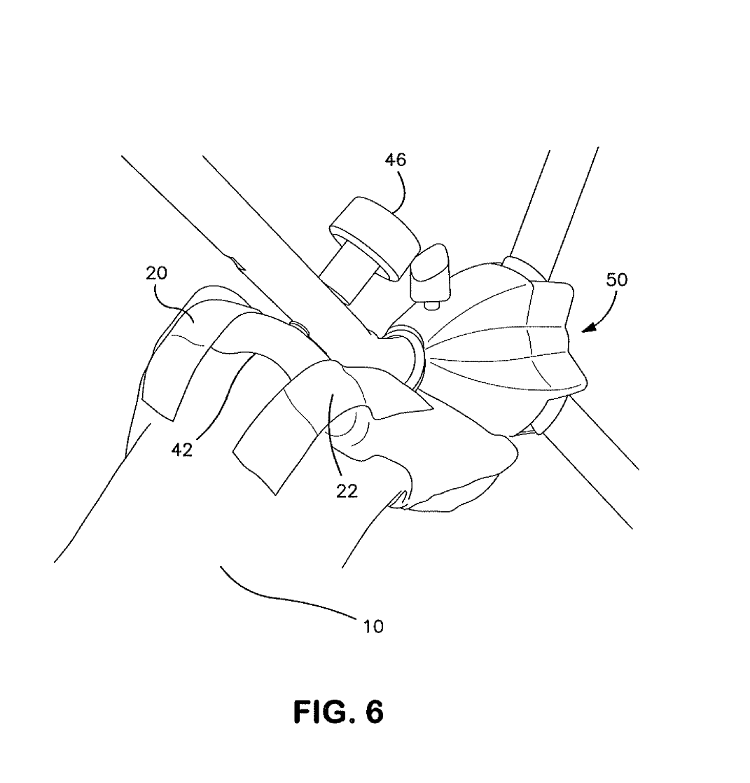

FIG. 6 illustrates the placement of the elastic loops 20 and 22 over the adjustable U-shaped lower protrusion 42 on the saxophone stand 50.

### EXAMPLE 1

A saxophone comprises a mouthpiece, a curved neck, keys, and a bell.

A saxophone may rest in a saxophone stand 50, whereby the bell of the saxophone rests on, and is secured by, the U-shaped top protrusion 40, and bottom of the bell rests against the U-shaped lower protrusion 42. The saxophone is secured to the saxophone stand by the securing strap 12.

The front side of the protective saxophone cover 10, as shown in FIG. 1, when in place is that surface against which a saxophone rests. The front side of the protective saxophone cover is smooth and non-abrasive. The protective cover comprises a U-shaped top and a rounded bottom. The U-shaped top of the protective cover comprises “ears” 24 and 26 at the top of the U. The width of the top of the protective saxophone cover is between 18 cm and 30 cm, and more preferable between 22 cm and 25 cm. The top of the ears of the U-shaped top of the protective saxophone cover are about 5 cm to 9 cm higher than the bottom of the U, and more preferably about 7 cm to 8 cm higher than the bottom of the U, as shown in FIG. 1.

The length of the protective saxophone cover, measured from the bottom of the U at the top of the protective saxophone cover to bottom of the rounded bottom of the protective saxophone cover is about 25 cm to 35 cm, and more preferably about 29 cm to 31 cm.

FIG. 3 depicts an exploded view of the back side of the protective saxophone stand cover 10 showing the flap 18 standing open 30.

The securing strap 12 is between 12 cm and 20 cm in length and more preferable between 15 cm and 18 cm in length. The securing strap is between about 1.0 cm and 3.0 cm in width and more preferably between about 1.5 cm and 2.5 cm in width. The connecting device 14 and its mating device 16 are approximately the same width as the securing strap. The connecting device 14 and the mating device 16 each are approximately 2.0 cm to 4.0 cm in length and may be of different lengths.

The elastic loops 22 and 24 are each approximately 12 cm to 16 cm in length, and more preferably approximately 14 cm to 15 cm in length with a width of about 1.0 cm and 3.0 cm in width and more preferably between about 1.5 cm and 2.5 cm, with loop 22 and loop 24 having approximately the same dimensions.

In this example, there is an upper opening 32 in the elastic loops 20 and 22, and a lower opening 34 in the elastic loops 20 and 22. The upper loops 32 are located about 10 cm to 25 cm from the bottom of the U at the top of the protective cover 10, and more preferably, about 14 cm to 20 cm from the bottom of the U at the top of the protective cover 10. Openings 32 on each elastic loops 20 and 22 are approximately the same dimensions, and the openings for each being large enough to allow the arms of the U-shaped lower protrusion 40 to fit inside said loops (see FIG. 6). The openings 32 are at least 0.5 cm wide.

In this example, the lower loops 34 are about 15 cm to 35 cm from the bottom of the U at the top of the protective cover 10, and more preferably, about 18 cm to 28 cm from the bottom of the U at the top of the protective cover 10. Openings 34 on each elastic loops 20 and 22 are approximately the same dimensions, and the openings for each being large enough to allow the arms of the U-shaped lower protrusion 40 to fit inside said loops (see FIG. 6). The openings 34 are at least 0.5 cm wide.

The protective cover 10 may be constructed of a soft non-abrasive material comprising silk, linen, Velvet®, foam, polyester, polyamide, velour, microfiber, suede, felt, leather, and cotton flannel.

The securing strap 12 may be constructed of an elastic material. When the securing strap 12 is connected to the mating device 16, a saxophone may be held in place on a saxophone stand 50. The connecting of the securing strap 12 and the mating device 16 is adjustable so that the securing strap 12 may hold a saxophone securely on a saxophone stand without damage to the saxophone. The connection between the securing strap 12 and the mating device 16 is easily released so that the saxophone may be quickly removed from the saxophone stand. The connecting device 14 and the mating device 16 comprise snaps, buttons, and self-adhering materials, such as Velcro®.

1. A protective saxophone stand cover for protecting saxophones from damage while said saxophones are resting on a saxophone stand, being placed on a saxophone stand, or being removed from saxophone stands, wherein said protective saxophone stand cover comprises
a. a front side,
b. a back side, comprising a top side and a lower side, wherein the top side contains a flap that fits over saxophone stand protrusions, and the lower side contains elastic bands that fit over adjustable saxophone stand protrusions, and
c. a securing strap.

2. A protective saxophone stand cover as in claim number 1 wherein the protective saxophone stand cover may be removably attached to a saxophone stand.

3. A protective saxophone stand cover as in claim number 1 wherein the protective saxophone stand cover is constructed of a soft non-abrasive material comprising silk, linen, Velvet®, foam, polyester, polyamide, velour, microfiber, suede, felt, leather, and cotton flannel.

4. A protective saxophone stand cover as in claim number 1 wherein the securing strap is long enough to hold a saxophone detachable fixed to a saxophone stand, preferably between 12 cm and 20 cm in length and between about 1.0 cm and 3.0 cm in width.

5. The securing strap as in claim 4 comprising an end fixedly attached to right side of the back of the protective saxophone stand cover and a distal end with a coupling device wherein said coupling device may removably attach to a mating device on the left side of the back of the protective saxophone stand cover.

6. The securing strap as in claim 4 comprising an end fixedly attached to left side of the back of the protective saxophone stand cover and a distal end with a coupling device wherein said coupling device may removably attach to a mating device on the right side of the back of the protective saxophone stand cover.

7. A protective saxophone stand cover as in claim number 1 wherein the securing strap is long enough to hold a saxophone detachable fixed to a saxophone stand, more preferably between 15 cm and 18 cm in length and between about 1.5 cm and 2.5 cm in width.

8. The securing strap as in claim 7 comprising an end fixedly attached to right side of the back of the protective saxophone stand cover and a distal end with a coupling device wherein said coupling device may removably attach to a mating device on the left side of the back of the protective saxophone stand cover.

9. The securing strap as in claim 7 comprising an end fixedly attached to left side of the back of the protective saxophone stand cover and a distal end with a coupling device wherein said coupling device may removably attach to a mating device on the right side of the back of the protective saxophone stand cover.

10. A protective saxophone stand cover as in claim number 1 wherein elastic loops are attached to the lower part of the back of the protective saxophone stand cover wherein each elastic loop is approximately 12 cm to 16 cm in length with a width of about 1.0 cm and 3.0 cm in width.

11. Elastic loops as in claim 10 wherein there are two or more openings wherein at least one opening is located about 10 cm to 25 cm from the top of the protective saxophone stand cover, and at least a second opening is located about 15 cm to 30 cm from the top of the protective saxophone stand cover, with said openings at least 0.5 cm in height.

12. A protective saxophone stand cover as in claim number 1 wherein elastic loops are attached to the lower part of the back of the protective saxophone stand cover wherein each elastic loop is more preferably approximately 14 cm to 15 cm in length with a width more preferably between about 1.5 cm and 2.5 cm.

13. Elastic loops as in claim 12 wherein there are two or more openings wherein at least one opening is located about 10 cm to 25 cm from the top of the protective saxophone stand cover, and at least a second opening is located about 15 cm to 30 cm from the top of the protective saxophone stand cover, with said openings at least 0.5 cm in height.

14. A protective saxophone stand cover as in claim number 1 wherein the protective saxophone stand cover is between 18 cm and 30 cm in width, and between 25 cm to 35 cm in length.

15. A protective saxophone stand cover as in claim number 1 wherein the protective saxophone stand cover is more preferable between 22 cm and 25 cm in width and more preferably about 29 cm to 31 cm in length.
